(19) United States
(12) Patent Application Publication
(10) Pub. No.: US 2026/0233618 A1
(43) Pub. Date: Aug. 13, 2026

(54) DC FAST-CHARGING BIDIRECTIONAL CONVERTER UTILIZING AN EXISTING E-MOTOR AND INVERTER

(71) Applicant: MAGNA POWERTRAIN OF AMERICA, INC., Troy, MI (US)

(72) Inventors: Hassan SHABBIR, Dearborn, MI (US); Aminesh GAJJAR, South Lyon, MI (US); Patrick LAMPLMAYR, St. Georgen (AT)

(21) Appl. No.: 19/154,655

(22) PCT Filed: Feb. 9, 2024
(86) PCT No.: PCT/US2024/015262

§ 371 Date: Aug. 7, 2025

Related U.S. Application Data
(60) Provisional application No. 63/445,737, filed on Feb. 15, 2023.

(51) Int. Cl. B60L 15/00; B60L 15/20; B60L 50/60; H02M 1/36; H02M 7/797

(52) U.S. Cl. CPC B60L 15/007; B60L 15/20; B60L 50/66; H02M 1/36; H02M 7/797; B60L 2210/40

(57) ABSTRACT

An electrical system includes an energy storage device, a traction motor having a plurality of machine windings, a power inverter, an external power source, and a mode control switch. The power inverter is connected to the energy storage device for receiving direct current (DC) power therefrom. The power inverter includes a plurality of pairs of semiconductor switches, with each pair of semiconductor switches of the plurality of pairs of semiconductor switches being configured to apply an alternating current (AC) power to a corresponding machine winding of the plurality of machine windings. The mode control switch is connected between a given machine winding of the plurality of machine windings and a corresponding pair of semiconductor switches of the pairs of semiconductor switches. The mode control switch is operable to selectively prevent current flow between the external power source and the corresponding pair of semiconductor switches.

### CROSS REFERENCE TO RELATED APPLICATIONS

This PCT international patent application claims the benefit of U.S. Provisional Patent Application No. 63/445,737 filed Feb. 15, 2023, the contents of which is incorporated herein by reference in its entirety.

### FIELD OF THE INVENTION

The present invention relates to bidirectional voltage converter utilizing vehicle power electronics and machine windings in an electric vehicles traction motor. The electrical system allows a vehicle charger of a lower voltage to be utilized by an electric vehicle with a higher voltage energy storage device in a boost mode, as well as providing the ability to reduce voltage from a higher voltage energy storage device to an external battery with a lower voltage in a buck mode.

### BACKGROUND OF THE INVENTION

This section provides background information related to the present disclosure which is not necessarily prior art.

Electric vehicles utilize charging systems to replenish energy storage devices within the vehicle after a period of operation. Electrical power is supplied by an external source and electrical componentry is utilized to convert the power into a state suitable for to be received to return the energy storage device to a recharged state.

There is currently a push for electric vehicles which operate at a higher nominal battery supply voltage than current electrical vehicle recharging facilities provide. Electric vehicle chargers typically provide only a voltage of 400 V, while the latest battery nominal voltages are 800 V or higher. Therefore, there is a need to provide a way to charge the electric vehicles with 800V or higher energy storage devices with the recharging facilities which supply lower voltages in an efficient and time effective manner. Utilizing and adding a traditional boost converter could be included in these newer higher voltage electric vehicles, but this adds cost, expense and requires space in the vehicle. Therefore, utilizing a traditional boost converter in a vehicle is not an effective solution. A solution modifying and utilizing the base electrical componentry already existing in the electric vehicle to create a bi-directional converter will be described. Using power traction inverter along with primary motor in addition with application specific external electronics can allow the recharger to convert the energy stored in the energy storage device in the vehicle in more efficient way such that the power can delivered to vehicle at a faster rate. The revised electrical componentry can function as a boost or a buck converter depending on the operational modes of various switches to provide either an increased voltage output from an external DC charger or a reduced voltage output to an external energy storage device.

### SUMMARY

This section provides a general summary of the many aspects associated with the inventive concepts embodied in the teachings of the present disclosure and is not intended to be considered a complete listing of its full scope of protection nor all of its features and advantages.

In accordance with an aspect of the present disclosure, an electrical system is provided. The electrical system includes an energy storage device, and a traction motor having a plurality of machine windings. The electrical system also includes a power inverter connected to the energy storage device for receiving direct current (DC) power therefrom. The power inverter includes a plurality of pairs of semiconductor switches. Each pair of semiconductor switches of the plurality of pairs of semiconductor switches is configured to apply an alternating current (AC) power to a corresponding machine winding of the plurality of machine windings. The electrical system also includes an external power source, and a mode control switch. The mode control switch is connected between a given machine winding of the plurality of machine windings and a corresponding pair of semiconductor switches of the pairs of semiconductor switches. The mode control switch is operable in a closed state to allow current flow therethrough. The mode control switch is also operable in an open state to prevent current flow between the external power source and the corresponding pair of semiconductor switches.

In accordance with an aspect of the present disclosure, a method of operating an electrical system is provided. The method includes: providing an energy storage device having a first voltage, a traction motor having a plurality of machine windings, a power inverter including a plurality of pairs of semiconductor switches, and an external power source having a second voltage that is different from the first voltage; applying, by a corresponding pair of semiconductor switches of the plurality of pairs of semiconductor switches, an alternating current (AC) power to a given machine winding of the plurality of machine windings and using direct current (DC) power from the energy storage device; selectively conducting, by a mode control switch, the AC power from the corresponding pair of semiconductor switches and to the given machine winding to operate the traction motor in a torque producing mode; and selectively blocking, by the mode control switch, current between the corresponding pair of semiconductor switches and the given machine winding to operate the electrical system in a power converter mode for transferring power between the energy storage device and the external power source.

These and other features and advantages of the present invention will become more readily appreciated when considered in connection with the following detailed description and appending drawings.

### BRIEF DESCRIPTION OF THE DRAWINGS

The drawings described herein are for illustrative purposes only of selected embodiments and are not intended to limit the scope of the present disclosure. The inventive concepts associated with the present disclosure will be more readily understood by reference to the following description in combination with the accompanying drawings wherein:

FIG. 1 is a block diagram of an electrical system in accordance with the present disclosure;

FIG. 2 shows a circuit schematic of the electrical system, in accordance with the present disclosure;

FIG. 3 shows the circuit schematic of FIG. 2, with arrows indicating current flow therethrough while operating in a first boost mode;

FIG. 4 shows the circuit schematic of FIG. 2, with arrows indicating current flow therethrough while operating in a second boost mode;

FIG. 5 shows the circuit schematic of FIG. 2, with arrows indicating current flow therethrough while operating in a first buck mode;

FIG. 6 shows the circuit schematic of FIG. 2, with arrows indicating current flow therethrough while operating in a second buck mode; and

FIG. 7 shows a flow chart illustrating steps in a method of operating an electrical system, in accordance with the present disclosure.

### DESCRIPTION OF THE ENABLING EMBODIMENTS

The following description of the electrical system and its usage is only exemplary in nature and is not intended to limit the present disclosure. As most current electric vehicle chargers provide only a voltage of 400 V, electric vehicles with 800V or higher energy storage devices often utilize a traditional boost converter. A solution modifying and utilizing the base electrical componentry already existing in the electric vehicle to create a boost converter will be described. Using the existing vehicles power traction inverter along with a traction motor in addition with application specific external electronics can allow the recharger to convert the energy stored in the energy storage device in the vehicle in more efficient way.

An example of the boost converter electrical system reutilizing the vehicle's electrical componentry is provided. The complete electrical system may include a rechargeable energy storage device with a power inverter connected to the energy storage device and provides converted electrical energy to the traction motor of the electric vehicle during normal operation of the electric vehicle. The modified electrical system is also capable of operating in a manner to supply a recharging voltage to the energy storage device after boosting the recharging voltage using an inductor of the traction motor and controlling switching elements of an inverter circuit. Specifically, a plurality of machine windings of the traction motor can be utilized, connected between the power inverter and the external recharging power source in combination with additional switches.

The same electrical system, with a revised scheme of controlling the switching elements of the inverter circuit, can operate as a forward buck converter. In this mode, the energy storage device operating at a higher voltage can provide a reduced voltage to an external energy storage device.

A polarity control switch (Z7) will be provided to block negative voltage from the external power source 13, 16. The polarity control switch (Z7) may conduct current during normal operation but will be turned off when the external power source 13, 16 is connected in a wrong direction. A converter startup switch (Z8) may progressively increase an amount of current therethrough over a predetermined period of time to provide a controlled rate of turn-on. The converter startup switch (Z8) may be controlled by a timing circuit which operates to reduce inrush and to allow for a soft start of the converter and protecting the power switches Z1-Z6. The converter startup switch (Z8) may be started in a linear mode of operation.

The polarity control switch (Z7) and the converter startup switch (Z8) may be turned off during normal operation, thereby eliminating any effect of the external power source 13, 16. Normal operation may include any time when the electrical system 10 is not being operated to charge the onboard energy storage device 12 using the external charger 16 or to supply power to the external energy storage device 13. The external energy storage device 13 and/or the external charger 16 may be collectively called an external power source 13, 16. In other words, the external power source 13, 16 may include either or both of the external energy storage device 13 and/or the external charger 16. Normal operation may include, for example, operating the inverter 18 to convert DC power from the onboard energy storage device 12 into AC power and to apply the AC power to the machine windings (L1, L2, L3) of the traction motor 14 to cause the traction motor 14 to generate a torque for propelling the vehicle 11.

A mode control switch (W1) is connected between one of the machine windings (L1, L2, L3) of the traction motor 14 and a corresponding pair of semiconductor switches (Z1/Z2, Z3/Z4, Z5/Z6) of the inverter 18. The mode control switch (W1) can be configured to transition between an open state and closed state to allow current flow from a semiconductor switch pair Z5 and Z6 of the inverter 18 and through a corresponding third winding L3 of the plurality of machine windings L1, L2, L3. The mode control switch (W1), in the open state, functions to prevent current flow between the external power source 13, 16, and semiconductor switch pair Z5 and Z6.

The electrical system 10 can include an inductor (L) connected in series between the plurality of machine windings L1, L2, L3 and the external power source 13, 16 wherein the inductor (L) is configured to mitigate at least one of current ripple or torque ripple.

It is an aspect of the present disclosure to provide an electrical system which can provide complete regulation of the output voltage across all DC voltage ranges.

It is an aspect of the present disclosure to provide operation in a bi-directional boost/buck mode.

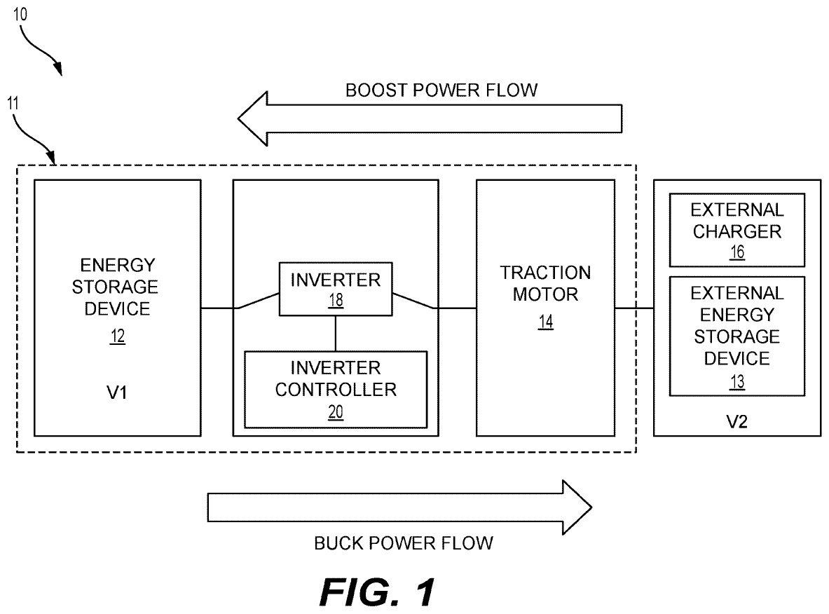

FIG. 1 shows a block diagram of the proposed electrical system 10. The electrical system 10 of the present disclosure may be used a vehicle 11, such as a passenger car or truck, which may be configured as an electric vehicle (EV) and/or a plug-in hybrid electric vehicle (PHEVs). An onboard energy storage device 12 is located on or within the vehicle 11 and stores electrical energy to provide power to the electrical system 10. The onboard energy storage device 12 may include a high voltage device which may be constructed of a multitude of individual battery packs arranged to provide direct current (DC) power output at a first voltage V1. The onboard energy storage device 12 may include electrochemical cells with lithium ion, NiMH, zinc air, or any other chemistry. As there are operational electrical load on the electric vehicles including power draw from a traction motor 14 which propels the electric or hybrid vehicle, the onboard energy storage device 12 must be replenished with energy after a period of operation.

The vehicle 11 and its onboard energy storage device 12 may be connected to an external power source 13, 16, which may have a second voltage V2 that is substantially lower than the first voltage V1 of the onboard energy storage device 12. The external power source 13, 16 may include an external charger 16, which may also be called an external charging system. The external charger 16 can apply, as an example, the second voltage V2 of 400 VDC, while the onboard energy storage device 12 operates at the first voltage VI, which can be 800 VDC or higher. To utilize the lower voltage output of a 400V external charger 16, the second voltage V2 must be increased, or stepped up. Such voltage boosting may be performed utilizing a traditional standalone boost converter or using the electrical system 10 of the present disclosure.

Additionally or alternatively, there can be a need to utilize the power within the onboard energy storage device 12 to provide power to an external energy storage device 13, which may also be called an off-board energy storage device, located outside of the vehicle 11 and operating at the second voltage V2 that is substantially less than the first voltage V1 of the onboard energy storage device 12. The external energy storage device 13 may include, for example, an energy storage device of a second electric vehicle or an external DC load. The connection to the external energy storage device 13 may be implemented only when the vehicle 11 is parked. In this situation the electrical system 10 of the present disclosure can operate as a forward buck converter decreasing the output voltage below the first voltage V1 voltage of 800V. Different values for either or both of the first voltage V1 and/or the second voltage V2 can also be utilized and the values provided are examples.

Continuing to refer to FIG. 1, the circuit connections and components of electrical system 10 including the onboard energy storage device 12, inverter 18, inverter controller 20, traction motor 14 and various electrical components which will be further described reside within the electric vehicle. In boost mode, the external charger 16 will provide a replenishing DC power source having the second voltage V2. The external charger 16 may be implemented by a typical DC fast charging system and/or by another electric vehicle in a vehicle-to-vehicle recharging power transfer. The external charger 16 will operate or provide a second voltage V2 which is lower than the first voltage VI of the onboard energy storage device 12. The electrical system 10 described is not limited if the external DC voltage source is provided via a charging cable or if it is provided via a wireless power transfer. In buck mode, the second voltage V2 will be represented by an external energy storage device 13. Inverter 18 is the electrical device that converts electricity derived from a Direct Current (DC) source, in this case from the onboard energy storage device 12, to Alternating Current (AC), which powers a traction motor 14.

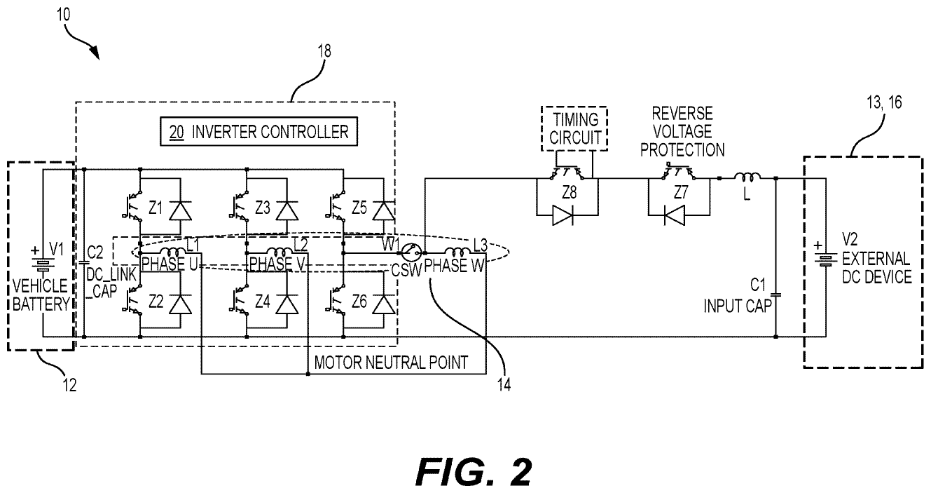

FIG. 2 shows a circuit schematic of the electrical system 10 of the present disclosure. The traction motor 14 includes one or more machine windings which are illustrated as machine windings L1, L2, and L3. During vehicle operation, machine windings L1, L2, and L3 provide three-phase current to create a rotating magnetic field to rotate a rotor of the traction motor 14. Inverter 18 can be a bidirectional DC-to-AC and AC-to-DC power converter. Inverter 18 includes a set of semiconductor switches (Z1-Z6) utilized to induce an alternating current of electricity provided to traction motor 14 via high frequency switching during vehicle operation. Each semiconductor switch Z1 through Z6 may be embodied as a voltage-controlled switching device in the form of a silicon insulated gate bipolar transistor (IGBT), a silicon carbide (SiC) metal-oxide semiconductor field effect transistor (MOSFET), a Gallium nitride (GaN) field-effect transistor (FET), or other suitable switch having a corresponding gate to which a gate signal is applied to change the on/off state of a given switch. There is typically at least one pair of semiconductor switches for each phase of the three-phase traction motor 114. Each pair of switches, e.g., switches Z5 and Z6 (Phase W), switches Z3 and Z4 (Phase V), and switches Z1 and Z2 (Phase U), may referred to as phase legs of inverter 18. For example, inverter 18 may include at least three (3) phase legs as shown in this example. Each phase leg of the inverter 18 is connected to a corresponding phase of one of the machine windings of traction motor 14. A DC link capacitor C2 can be connected across positive and negative terminals of the onboard energy storage device 12. The inverter 18 also includes inverter controller 20 which controls operation of semiconductor switches ZI through Z6 by supplying control signals to gates thereof to cause the semiconductor switches Z1-Z6 to transition between an open state and a closed state.

A mode control switch W1 is positioned between machine winding L3 to provide a selectable interruption of current flow from the external power source 13, 16 and semiconductor switch pair Z5 and Z6. The mode control switch W1 may include a relay type switch, and which may be operated for switching the converter between a power converting mode and a torque producing mode. The mode control switch W1 may be operated in a closed state to conduct current during the motor mode, when the traction motor 14 is operated to consume electrical power and to produce a traction torque. The mode control switch W1 may be operated in an open state to inhibit current therethrough in the power converter modes, when the machine windings L1, L2, L3 are used in the power converting mode for converting power between the onboard energy storage device 12 and the external power source 13, 16.

The polarity control switch Z7 may include a semiconductor switch configured to block current from the external power source 13, 16. The polarity control switch Z7 can be positioned as shown, between a positive terminal of the external power source 13, 16, and the machine windings L1, L2, L3. The polarity control switch Z7 may be used to implement a Reverse Battery Voltage Protection function by operating in a non-conductive state when the external power source 13, 16 is connected incorrectly. The converter startup switch Z8 may include a semiconductor switch device and which may be operated in an linear mode for startup. The converter startup switch Z8 may be positioned near the external power source 13, 16. The converter startup switch Z8 may be connected in series with the polarity control switch Z7, between the positive terminal of the external power source 13, 16 and the machine windings L1, L2, L3. By controlling a rate of turn-on via a timing circuit, the converter startup switch Z8 may function to limit an inrush current and will allow for soft-start of the converter.

Switches Z7 and Z8 can be optionally used to provide further functionality to electrical system 10 but are not absolutely required for boost mode operation. Switches Z7 and Z8 may each be turned off (i.e. in a non-conductive state) during the torque producing mode, when the traction motor 14 is operated to produce torque, e.g. for propelling the vehicle 11. The electrical system 10 can also include a filter inductor L connected in series with the external power source 13, 16 and one or more of the machine windings L1, L2, L3 to reduce current or torque ripple of the traction motor 14. The connection and physical placement of the polarity control switch Z7, the converter startup switch Z8, and/or the filter inductor L as shown in this example should not be considered limiting nor are all components required for operation in the torque producing mode or the power converting modes. An input capacitor C1 may also be connected across positive and negative terminals of the external power source 13, 16.

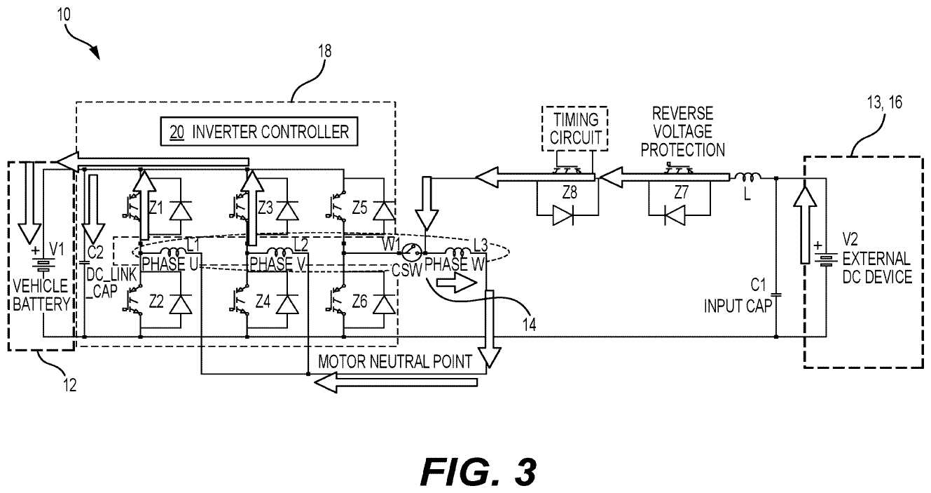

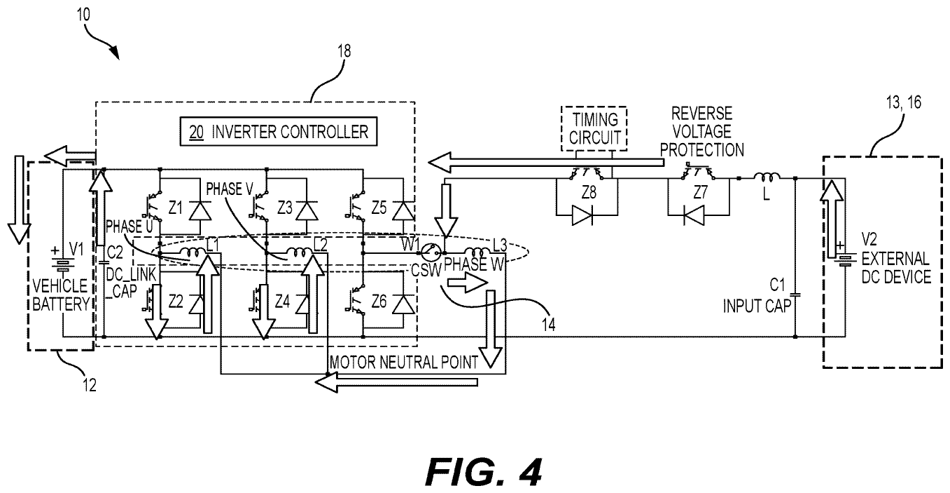

FIG. 3, and FIG. 4 are circuit schematics of the proposed electrical system showing the energy flow in the boost operational mode when the external power source 13, 16 has been connected and the external power source 13, 16 has a second voltage V2 that is higher than the first voltage V1 of the onboard energy storage device 12. As a non-limiting example, the second voltage V2 of the external power source 13, 16 may be 400V while the onboard energy storage device 12 may have a first voltage V1 of 800V. In the examples provided, the inverter controller 20 will control operation of the semiconductor switches ZI to Z6 described to implement a boost operating mode between V2 and V1. The inverter controller 20 can utilize parameters to output a PMW signal to cause one or more of the semiconductor switches ZI to Z6 to operate as further described. In this boost operational mode switch W1 is in an open state and maintained in an open state to prevent current flow from the external power source 13, 16 to semiconductor switches Z5 and Z6, directing current flow to machine winding L3. Semiconductor switches Z5 and Z6 remain open in a non-current conducting mode. Semiconductor switch pairs Z3 and Z4 and semiconductor switch pairs Z1 and Z2 may be operated using a pulse-width modulation (PWM) control technique.

To increase, or step-up, the second voltage V2 from the external power source 13, 16, the inverter controller 20 transitions the semiconductor switches Z1 and Z3 between the closed conducting state (FIG. 3) and the open state (FIG. 4) resulting in electrical system 10 performing a boost conversion where inductor current is decreasing in machine windings L1, L2, and L3 and DC link capacitor C2 is being charged. This arrangement allows all motor windings to be utilized in the boost conversion, with winding L3 in series with parallel machine windings L2 and L1. Alternatively, semiconductor switches Z2 and Z4 transition between the open state (FIG. 3) and the closed conducting state (FIG. 4) resulting in an increase of inductor current in machine windings L1, L2, and L3. The DC link capacitor C2 provides energy at an increased voltage to the onboard energy storage device 12.

During boost operation switches in leg Z5/Z6 are not used, however, they could be utilized to determine state of health estimation of the battery by putting a step load on the battery. The Hybrid Pulse Power Characterization (HPPC) testing can be applied to determine the dynamic performance over the usable voltage ranges of the onboard energy storage device 12 providing enhanced information to the master controller about the battery parameters under several predetermined load conditions.

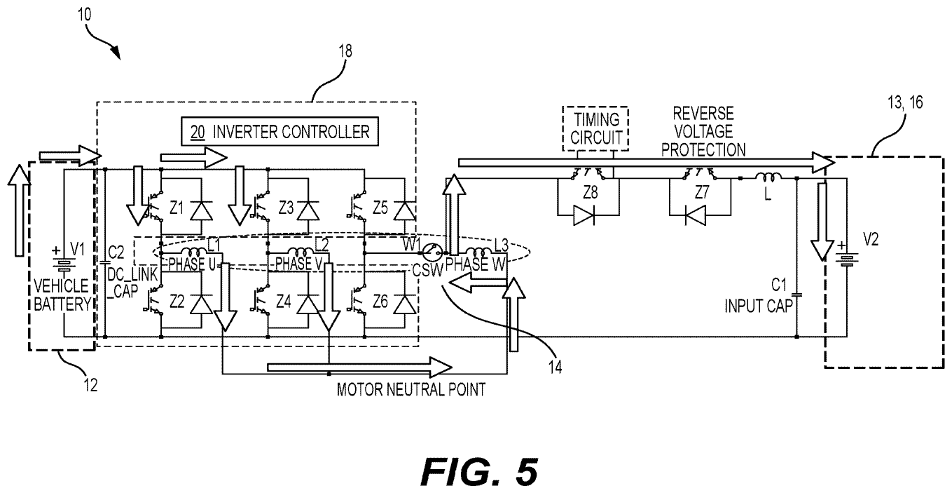

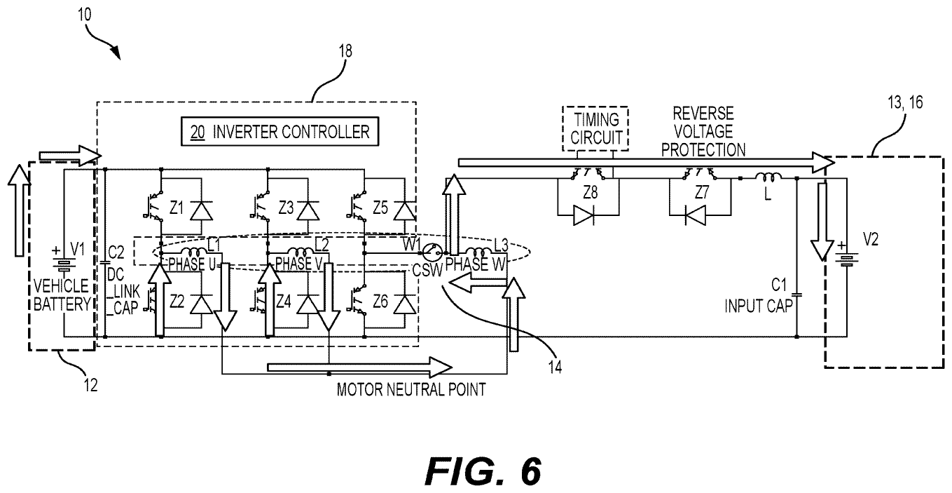

FIG. 5 and FIG. 6 are circuit schematics of the proposed electrical system showing the energy flow in the buck operational mode when the external energy storage device 13 has been connected and the external power source 13, 16 has a second voltage V2 that is lower than the first voltage VI of the onboard energy storage device 12. As a non-limiting example, the external energy storage device 13 may have a second voltage V2 of 400V while the onboard energy storage device 12 may have a first voltage V1 of 800V. Inverter controller 20 will control operation of the semiconductor switches described to implement an interleaved buck operating mode between V1 and V2. Inverter controller 20 can utilize parameters to output a PMW signal to cause one or more inverter switches Z1 to Z6 to operate as further described. In this buck operational mode switch W1 is in an open state and maintained in an open state to direct current flow from the onboard energy storage device 12 to machine winding L3 and prevent current flow to semiconductor switches Z5 and Z6. Semiconductor switches Z5 and Z6 remain open in a non-current conducting mode. Semiconductor switch pairs Z3 and Z4 and semiconductor switch pairs Z1 and Z2 may be operated using the PWM control technique.

To decrease, or step-down, the voltage from vehicle battery, the inverter controller 20 transitions the semiconductor switches Z1 and Z3 between the closed conducting state (FIG. 5) and the open state (FIG. 6) resulting in electrical system 10 and inductors L1, L2, and L3 perform a buck conversion which can reduce the voltage from the first voltage VI to the second voltage V2. Alternatively, semiconductor switches Z2 and Z4 transition between the open state (FIG. 5) and the closed conducting state (FIG. 6). This arrangement allows all motor windings L1, L2, L3 to be utilized in the buck conversion, with parallel machine windings L2 and L1 in series with winding L3. Power flows from the onboard energy storage device 12, through the interleaved buck converter formed by a first leg Z1/Z2 and a second leg Z3/Z4, and to the external energy storage device 13. The semiconductor switches Z1, Z2, Z3, Z4, Z5, Z6 of the inverter 18 may work in a complementary mode along with the machine windings L1 and L2 to smooth the ripple current. The polarity control switch Z7 and/or the converter startup switch Z8 may provide reverse battery protection.

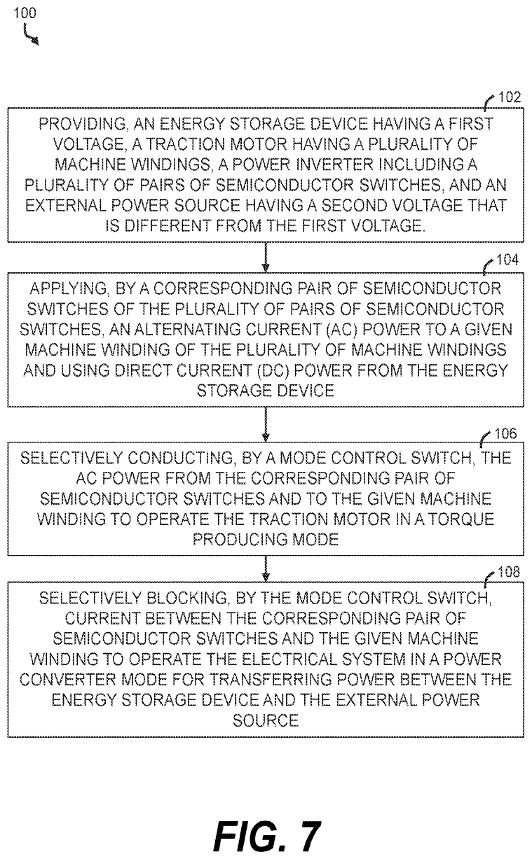

FIG. 7 shows a flow chart illustrating steps in a method 100 of operating an electrical system. As can be appreciated in light of the disclosure, the order of operation within the method is not limited to the sequential execution as illustrated in FIG. 7, but may be performed in one or more varying orders as applicable and in accordance with the present disclosure.

The method 100 includes providing, at step 102, an energy storage device having a first voltage, a traction motor having a plurality of machine windings, a power inverter including a plurality of pairs of semiconductor switches, and an external power source having a second voltage that is different from the first voltage. For example, the method 100 may be performed using the electrical system 10 of the present disclosure.

The method 100 also includes applying, at step 104, and by a corresponding pair of semiconductor switches of the plurality of pairs of semiconductor switches, an alternating current (AC) power to a given machine winding of the plurality of machine windings and using direct current (DC) power from the energy storage device. For example, semiconductor switches Z5/Z6 of the inverter 18 may be commanded by the inverter controller 20 to apply the AC power to the L3 machine winding of the traction motor 14.

The method 100 also includes selectively conducting, at step 106, and by a mode control switch, the AC power from the corresponding pair of semiconductor switches and to the given machine winding to operate the traction motor in a torque producing mode. For example, the mode control switch W1 may be operated in a conducting mode to conduct AC current from the semiconductor switches Z5/Z6 to the L3 machine winding to operate the traction motor 14 in the torque producing mode for accelerating the vehicle 11.

The method 100 also includes selectively blocking, at step 108, and by the mode control switch, current between the corresponding pair of semiconductor switches and the given machine winding to operate the electrical system in a power converter mode for transferring power between the energy storage device and the external power source. For example, the mode control switch W1 may be operated in a non-conducting mode to block current between the semiconductor switches Z5/Z6 and the L3 machine winding to the electrical system 10 in a power converter mode, such as a buck mode or a boost mode, for transferring power between the external power source 13, 16 and the onboard energy storage device 12.

In some embodiments, the energy storage device is an onboard energy storage device located on or within a vehicle, and wherein the traction motor is configured to propel the vehicle.

In some embodiments, operating the electrical system in the power converter mode includes operating the electrical system in a boost mode to transfer power from the external power source and to the energy storage device.

In some embodiments, operating the electrical system in the power converter mode includes operating the electrical system in a buck mode to transfer power from the energy storage device and to the external power source.

In some embodiments, the method 100 further includes selectively blocking, by a polarity control switch and in response to the external power source being connected with an incorrect polarity, current between the external power source and the given machine winding of the plurality of machine windings. For example, the polarity control switch (Z7) may be operated in an non-conductive mode to block current flow therethrough when the external power source 13, 16 is connected in a wrong direction.

In some embodiments, the method 100 further includes progressively increasing, over a predetermined period of time, by a converter startup switch, current between the external power source and the given machine winding of the plurality of machine windings. For example, the converter startup switch (Z8) may be operated, using a signal from a timing circuit, to increase an amount of current therethrough over the predetermined period of time and to provide a controlled rate of turn-on to reduce inrush and to allow for a soft start of the electrical system 10 in the power converter mode. The converter startup switch (Z8) may be started, for example, in a linear mode of operation.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varies in many ways. Such variations are not to be regarded as a departure from the disclosure, and all such modifications are intended to be included within the scope of disclosure.

What is claimed is:

1. An electrical system, comprising:
an energy storage device;
a traction motor having a plurality of machine windings;
a power inverter connected to the energy storage device for receiving direct current (DC) power therefrom, the power inverter including a plurality of pairs of semiconductor switches, each pair of semiconductor switches of the plurality of pairs of semiconductor switches being configured to apply an alternating current (AC) power to a corresponding machine winding of the plurality of machine windings;
an external power source; and
a mode control switch connected between a given machine winding of the plurality of machine windings and a corresponding pair of semiconductor switches of the pairs of semiconductor switches, wherein the mode control switch is operable in a closed state to allow current flow therethrough, and wherein the mode control switch is operable in an open state to prevent current flow between the external power source and the corresponding pair of semiconductor switches, and
wherein the given machine winding of the plurality of machine windings is further arranged to receive current from the external power source via a conductor when the mode control switch is in the open state.

2. The electrical system of claim 1, wherein the electrical system is configured to cause the mode control switch to be in the closed state for operating the inverter to apply the alternating current (AC) power to the corresponding machine winding and to cause the traction motor to generate a torque, and wherein the electrical system is configured to cause the mode control switch to be in the open state for operating the electrical system in a power converter mode to transfer power between the energy storage device and the external power source.

3. The electrical system of claim 2, wherein the energy storage device has a first voltage and the external power source has a second voltage that is lower than the first voltage, and
wherein operating the electrical system in the power converter mode includes operating the electrical system in a boost mode to transfer power from the external power source and to the energy storage device.

4. The electrical system of claim 2, wherein the energy storage device has a first voltage and the external power source has a second voltage that is lower than the first voltage, and
wherein operating the electrical system in the power converter mode includes operating the electrical system in a buck mode to transfer power from the energy storage device and to the external power source.

5. The electrical system of claim 1, wherein the energy storage device is an onboard energy storage device located on or within a vehicle, and wherein the traction motor is configured to propel the vehicle.

6. The electrical system of claim 1, wherein the energy storage device has a first voltage and the external power source has a second voltage that is substantially lower than the first voltage.

7. The electrical system of claim 1, further comprising a polarity control switch connected between the external power source and the given machine winding of the plurality of machine windings, wherein the electrical system is configured to cause the polarity control switch to block current therethrough in response to the external power source being connected with an incorrect polarity.

8. The electrical system of claim 1, further comprising a converter startup switch connected between the external power source and the given machine winding of the plurality of machine windings, wherein the electrical system is configured to cause the converter startup switch to progressively increase a current flow therethrough over a predetermined period of time.

9. The electrical system of claim 1, further comprising an inductor connected between the external power source and the given machine winding of the plurality of machine windings and for mitigating at least one of: a current ripple, or a torque ripple.

10. A method of operating an electrical system, the method comprising:
providing an energy storage device having a first voltage, a traction motor having a plurality of machine windings, a power inverter including a plurality of pairs of semiconductor switches, and an external power source having a second voltage that is different from the first voltage;
applying, by a corresponding pair of semiconductor switches of the plurality of pairs of semiconductor switches, an alternating current (AC) power to a given machine winding of the plurality of machine windings and using direct current (DC) power from the energy storage device;
selectively conducting, by a mode control switch, the AC power from the corresponding pair of semiconductor switches and to the given machine winding to operate the traction motor in a torque producing mode; and
selectively blocking, by the mode control switch, current between the corresponding pair of semiconductor switches and the given machine winding to operate the electrical system in a power converter mode for transferring power between the energy storage device and the external power source, and
wherein the given machine winding of the plurality of machine windings is further arranged to receive current from the external power source via a conductor when the mode control switch is in an open state.

11. The method of claim 10, wherein the energy storage device is an onboard energy storage device located on or within a vehicle, and wherein the traction motor is configured to propel the vehicle.

12. The method of claim 10, wherein operating the electrical system in the power converter mode includes operating the electrical system in a boost mode to transfer power from the external power source and to the energy storage device.

13. The method of claim 10, wherein operating the electrical system in the power converter mode includes operating the electrical system in a buck mode to transfer power from the energy storage device and to the external power source.

14. The method of claim 10, further comprising selectively blocking, by a polarity control switch and in response to the external power source being connected with an incorrect polarity, current between the external power source and the given machine winding of the plurality of machine windings.

15. The method of claim 10, further comprising progressively increasing, over a predetermined period of time, by a converter startup switch, current between the external power source and the given machine winding of the plurality of machine windings.

16. The electrical system of claim 1, wherein the external power source is a single-phase DC supply.

17. The method of claim 10, wherein the external power source is a single-phase DC supply.
